(19) United States
(12) Patent Application Publication
(10) Pub. No.: US 2014/0282733 A1
(43) Pub. Date: Sep. 18, 2014

(54) INFORMATION PROCESSING DEVICE, INFORMATION PROCESSING METHOD, AND PROGRAM

(71) Applicant: Sony Corporation, Tokyo (JP)

(72) Inventors: Mami Okumura, Kanagawa (JP); Mayu Irimajiri, Tokyo (JP); Takehiro Hagiwara, Tokyo (JP); Ryo Nakahashi, Tokyo (JP); Mitsuhiro Miyazaki, Kanagawa (JP)

(73) Assignee: SONY CORPORATION, Tokyo (JP)

(21) Appl. No.: 14/353,587

(22) PCT Filed: Oct. 31, 2012
(86) PCT No.: PCT/JP2012/007001

§ 371 Date: Apr. 23, 2014

(30) Foreign Application Priority Data
Nov. 4, 2011 (JP) 2011-242025

(51) Int. Cl. H04N 21/482; H04N 21/472

(52) U.S. Cl. CPC H04N 21/4826; H04N 21/472
USPC 725/46

(57) ABSTRACT

An information processing apparatus includes a display and a controller that controls display of a current program. The controller also controls display of a plurality of first images in a first arrangement. Each first image corresponds to content of the current program. The controller additionally controls display of a plurality of second images in a second arrangement. Each second image corresponds to content associated with a user.

### CROSS-REFERENCE TO RELATED APPLICATION

The present application claims priority from Japanese Patent Application No. JP 2011-242025 filed in the Japanese Patent Office on Nov. 4, 2011, the entire content of which is incorporated herein by reference.

### TECHNICAL FIELD

The present disclosure relates to an information processing device, an information processing method, and a program.

### BACKGROUND ART

In recent years, due to the proliferation of the Internet and mobile terminals such as portable equipment, information present in the world has increased explosively and diversified. In this regard, Japanese Patent Application JP 2011-138197A discloses that information is extracted based on relevance among information elements.

### SUMMARY

### Technical Problem

However, a total number of pieces of content that can be read by a user is limited, so that it is difficult for the user to read all information. In addition, since the change in information is deficient when the information is presented or recommended to the user based on information evaluation by virtue of the information relevance, it is difficult to present the user with fresh information in conformity with the user's interests. For this reason, a structure capable of visually presenting users with fresh information in conformity with the users' interests among a large quantity of flooding information has been desired.

### Solution to Problem

In one illustrative embodiment, an information processing apparatus includes: a display; and a controller to control: display of a current program; display of a plurality of first images in a first arrangement, wherein each first image corresponds to content of the current program; and display of a plurality of second images in a second arrangement, wherein each second image corresponds to content associated with a user.

In another illustrative embodiment, a computer-implemented method is executed by a processor and includes: displaying a current program; displaying a plurality of first images in a first arrangement, wherein each first image corresponds to content of the current program; and displaying a plurality of second images in a second arrangement, wherein each second image corresponds to content associated with a user.

### Advantageous Effects of Invention

According to the present disclosure, it is possible to visually present a user with fresh information in conformity with the user's interests among a large quantity of flooding information.

### BRIEF DESCRIPTION OF DRAWINGS

FIG. 1 is a diagram schematically illustrating a display screen of a system in accordance with an embodiment of the present disclosure;

FIG. 2 is a schematic diagram illustrating a case in which a user has selected content in a vertical band;

FIG. 3 is a schematic diagram illustrating a case in which a user has focused on the content in a vertical band;

FIG. 4 is a schematic diagram illustrating a state focused on the content in a horizontal band;

FIG. 5 is a schematic diagram illustrating an example in which the content of FIG. 1 in the vertical band is radially arranged around content of a seed;

FIG. 6 is a schematic diagram illustrating variations of arrangement of seed content of, booming content relevant to content being watched, and booming content based on the interests of a user;

FIG. 7 is a schematic diagram illustrating variations of arrangement of seed content of, booming content relevant to content being watched, and booming content based on the interests of a user;

FIG. 8 is a schematic diagram illustrating a main portion of a system in accordance with an embodiment of the present disclosure;

FIG. 9 is a flowchart illustrating a process in accordance with an embodiment of the present disclosure;

FIG. 10 is a schematic diagram illustrating a specific example of a configuration in accordance with an embodiment of the present disclosure;

FIG. 11 is a flowchart illustrating a specific process in accordance with an embodiment of the present disclosure;

FIG. 12 is a schematic diagram illustrating a score calculation technique;

FIG. 13 is a schematic diagram illustrating a specific algorithm;

FIG. 14 is a schematic diagram illustrating a state in which celebrities B to D are acquired by increasing the number of hops with respect to a celebrity A;

FIG. 15 is a schematic diagram illustrating an example of score calculation;

FIG. 16 is a schematic diagram illustrating an example in which each piece of information is arranged based on the calculated score;

FIG. 17 is a schematic diagram illustrating individualization of the score calculation technique by a user;

FIG. 18 is a schematic diagram illustrating an example in which a user directly inputs a celebrity on whom information is to be obtained;

FIG. 19 is a schematic diagram illustrating an example in which a user directly inputs a “celebrity A” from a television receiver;

FIG. 20 is a schematic diagram illustrating an example in which information other than that on a celebrity is input to an input unit;

FIG. 21 is a schematic diagram illustrating an example in which information on complementation between information is presented;

FIG. 22 is a schematic diagram specifically illustrating information connecting two pieces of information described in FIG. 21;

FIG. 23 is a schematic diagram illustrating a technique of extracting content that connects content to content in FIG. 22; and

FIG. 24 is a schematic diagram illustrating another example of FIG. 10.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, the description will be made in the following order:

1. Example of configuration of user interface of system according to embodiment of present disclosure
2. Example of configuration of system according to embodiment of present disclosure
3. Specific example of configuration according to embodiment of present disclosure

### 1. Example of Configuration of User Interface of System According to Embodiment of Present Disclosure

First, a configuration of a user interface of a system 100 according to a first embodiment of the present disclosure will be described with reference to FIG. 1. FIGS. 1 to 5 are schematic diagrams illustrating display screens of the system 100 according to embodiments of the present disclosure. The system 100 according to embodiments of the present disclosure has a display screen 102 (touch panel) on which a touch operation may be carried out, and illustrates herein an example of a device capable of receiving television broadcasting waves and being connected to a network. In addition, the system 100 is not limited to the case in which the touch operation is carried out on the display screen 102 but may be employed in cases in which operations are input by other operation input units (including a keyboard, a mouse, various recognition techniques such as infrared light, a remote controller, and so forth).

As shown in FIG. 1, in the center of the display screen 102, content (a moving image) 104 being watched by a user is displayed in the center of the display screen 102. Hereinafter, the content being displayed in the center of the display screen 102 may be referred to as seed content. Here, a case in which the user watches a song program is illustrated as an example. Information on the electronic program listings relevant to the content 104 (a title of the content, channel information, names of cast members, and so forth), and so forth is displayed around the content 104. Text information relevant to the content is displayed to the right of the content 104.

A plurality of pieces of content (pieces of content 106 in a vertical band/pieces of content 108 in a horizontal band) are displayed around the seed content 104 at the same time. The pieces of content 106 in the vertical band are arranged in upper and lower directions to the left of the seed content 104, are relevant to the content 104 being watched, and are displayed as booming content (SNS, VoD, broadcasting, and so forth). The pieces of content 108 in the horizontal band are arranged in right and left directions below the seed content 104, and are displayed as content based on the user's interests (weather forecast, favorite actor or actress, SNS of the user, and so forth). The pieces of content 106 and 108 in the vertical and horizontal bands are content of multisources (multimedia), and include not only information received from the television broadcasting waves but also various information such as information acquired from the web (YouTube, Twitter), and so forth. The pieces of content 106 are relevant to the content 104, extracted from the television broadcasting waves, the web, and so forth by an engine that will be described later and then displayed.

The pieces of content 106 arranged to the left of the content 104 have high booming values as topics with respect to the content 104. That is, the pieces of content 106 are relevant to the content 104 and also relate to information having high boom (popularity) among the public. The pieces of content 106 are arranged in a vertical (upper and lower) direction in a booming value order.

In addition, the pieces of content 106 are arranged based on the taste of the user. When the pieces of content 106 are arranged on the upper side, the pieces of content are general ones far from the user's interests, and when the pieces of content 106 are arranged on the lower side, the pieces of content are closer to the user's interests. That is, when the pieces of content 106 are arranged on the upper side, the pieces of content have high booming values but are unrelated to the user's interests. On the other hand, when the pieces of content 106 are arranged to be on the lower side, the pieces of content have lower booming values compared to the pieces of content 106 arranged on the upper side but are closer to the user's interests.

The pieces of content 106 in the vertical band may be moved in upper and lower directions by scroll operations. When the screen of FIG. 1 is displayed for the first time, the content 106a positioned to the left of the content 104 has strong relevance to the seed content 104 and is also content having a high booming value.

When the pieces of content 106 are scrolled down, the pieces of content 106 “closer” to the user's interests are displayed. Meanwhile, when the pieces of content 106 are scrolled up, the pieces of content 106 “farther” from the user's interests are displayed. The scroll may be performed by touch operations on the display screen 102.

The pieces of content 108 in the horizontal band are usually displayed with no relevance to the seed content 104, and the pieces of content most suiting the user's interests are displayed. That is, the pieces of content 108 are information to be watched and checked by the user, and favorite information of the user. For example, the pieces of content 108 are extracted by an information processing device 100 based on keywords registered by the user and then displayed. In addition, when the interests of the user are already accumulated in an external server, a network, or the like, the pieces of content 108 extracted based on the accumulated interests are displayed. In addition, even when the information processing device 100 is not connected to the network, interest information of the user may be accumulated by the information processing device 100 in association with operations of the user, and pieces of content 108 may be extracted and displayed based on the accumulated interest information.

In addition, arrangement of the pieces of content 106 and 108 is not limited to the case described above, and the pieces of content 106 may be arranged in the horizontal band and the pieces of content 108 may be arranged in the vertical band. Even in this case, the pieces of content 106 in the horizontal band may be arranged such that the degree of interest of the user increases when the pieces of content are closer to the pieces of content 108 in the vertical band.

The user may acquire detailed information on the selected pieces of content 106 and 108 by selecting (double-tapping/enter key operation/determination) the respective pieces of content 106 and 108 displayed on the display screen 102. FIG. 2 is a schematic diagram illustrating the case in which the user has selected the pieces of content 106 in the vertical band. As shown in FIG. 2, when the user selects any one of the pieces of content 106 in the vertical band, the content 106 is displayed in the center (seed) of the display screen 102. When the selected content 106 does not fit within one screen of the display screen 102, a scroll bar is displayed to allow the pieces of content 106 to be checked while scrolling through a layout of the pieces of content 106 being held.

FIG. 3 illustrates the case in which the user has focused on the content 106a in the vertical band, that is, the case in which the user puts an operating finger on the content 106a without selecting the content 106a. In this case, as shown in FIG. 3, a reason for relevance 109 between the content 104 being watched and the content 106a is displayed to the right of the seed content 104. In addition, the surrounding of the focused content 106a is highlighted and the content 106a is displayed to be floated in the front. In addition, by focusing on the content 106a, lower portions of pieces of the content 106 in the vertical band overlap the pieces of content 108 in the horizontal band and then displayed. When the highlighted content 106 is determined by operating the double-tap or the enter key in this state, the pieces of content 106 may be selected so that the pieces of content 106 become seeds and displayed in the center of the display screen 102 as shown in FIG. 2.

FIG. 4 illustrates the state in which the pieces of content 108 in the horizontal band are focused on. As in the pieces of content 106 in the vertical band, when one of the pieces of content 108 in the horizontal band is focused on, the surroundings of the focused content 108 are highlighted and the content 108 is displayed to be floated in the front. When the highlighted content 108 is determined by operating the double-tap or the enter key in this state, the content 108 may be selected, and the content 108 becomes a seed. As shown in FIG. 4, when the pieces of content 108 in the horizontal band are focused, a left portion of the pieces of content 108 in the horizontal band overlap the pieces of content 106 in the vertical band and are then displayed.

FIG. 5 is a schematic diagram illustrating an example in which the pieces of content 106 in the vertical band of FIG. 1 are radially arranged around the seed content 104. The seed content 104 is displayed in the center of the display screen 102. The pieces of content 106 in the vertical band shown in FIG. 1 are radially displayed around the content 104. The intensity of the relevance between the pieces of content 106 and the content 104 can be, for example, indicated by a distance between the pieces of radially displayed content 106 and the seed content 104. Or the intensity of the booming can be represented by a thickness of the line 110 connecting the content 104 with the content 106 or a size of the content 106 on the display screen 102. For example, the line 110 is displayed as a thicker line when the booming value of the content 106 increases. In addition, the size may be displayed to be larger on the display screen 102 when the booming value of the content 106 increases.

The relevance to the user's interests is also represented in accordance positions of the pieces of content 106 in upper and lower directions in FIG. 5. The pieces of content 106 arranged in upper positions are far from the user's interests, and the pieces of content 106 arranged in lower positions are closer to the user's interests. The pieces of content 106 may be moved in the upper and lower directions by the scroll. It is thus possible for the user to scroll through the screen and recognize from the pieces of content 106 close to the user's interests to the pieces of content 106 far from the interests on the display screen 102.

In addition, in FIG. 5, the pieces of content 108 in the horizontal band are arranged in right and left directions in the lower portion of the screen as in FIG. 1. More of the pieces of content 108 in the horizontal band are displayed in FIG. 5 than in FIG. 1.

A date and a time are displayed on the lower right side of the display screen 102. In addition, a user name is displayed on the lower left side of the display screen 102. Since the user's interests are different for each user, the information processing device 100 carries out different display for each user in accordance with the user name.

According to the display of FIG. 5, since more of the pieces of content 106 and 108 are displayed in comparison with the display of FIG. 1, display perspicuity may be enhanced. In addition, the relevance between the pieces of content 106 and the content 104 and the booming value may be visually recognized based on a distance between the pieces of content 104 and the pieces of content 106, a thickness of the line 110, and sizes of the pieces of content 106.

As described with reference to FIG. 3, when one of the pieces of content 106 is focused on, a relevance reason 109 indicating a connection between the content 104 and the focused content 106 is displayed to the right of the content 104. In this case, the relevance reason 109 to the right of the content 104 is changed and displayed in accordance with the focused content 106.

In addition, as another example, when program information based on the electronic program listing is displayed to the right of the content 104, a portion having a high relevance to the focused content 106 is highlighted among the text of the program information. In this case, when other content 106 is focused on, the highlight position of the text of the program information is changed in accordance with the connection between the focused content 106 and the content 104.

This configuration enables the user to know how the highlighted content 106 is connected to the content 104. Accordingly, when the user selects the content 106, a variety of information regarding the content 106 may be given.

FIGS. 6 and 7 are schematic diagrams illustrating variations of arrangement of the seed content 104, the booming content 106 relevant to the content 104 being watched, and the booming content 108 based on the user's interests.

In FIGS. 6 and 7, the seed content 104 is “R,” the booming content 106 relevant to the content 104 being watched is “P,” and the booming content 108 based on the user's interests is “Q.”

FIG. 6 illustrates an example in which the pieces of booming content 108 (“Q”) based on the user's interests are arranged in a row on a lower side of the display screen 102 and the pieces of content 106 (“P”) are arranged in several columns (herein, two columns) in a similar way to FIG. 1. Here, in FIG. 6A, the pieces of content 106 are arranged in two columns to the left of the seed content 104. As a result, the seed content 104 is disposed slightly to the right from the center of the display screen 102. In addition, FIG. 6B illustrates an example in which the pieces of content 106 are arranged in one column each to the right and left of the seed content 104.

FIG. 7 illustrates examples in which the booming content 108 (“Q”) based on the user's interests is not displayed. Among these, FIG. 7A illustrates an example in which the seed content 104 (“R”) is disposed in the center of the upper and lower directions of the display screen 102 and the pieces of content 106 (“P”) are disposed above and below the seed content 104 (“R”). In addition, FIG. 7B illustrates an example in which the seed content 104 (“R”) is disposed in a relatively narrow range on the lower left side of the display screen 102 and the pieces of content 106 (“P”) are disposed in a relatively large range of the display screen 102.

In addition, FIG. 7C illustrates an example in which the seed content 104 (“R”) is disposed in a relatively narrow range on the upper center side of the display screen 102 and the pieces of content 106 (“P”) are disposed in a relatively large range of the display screen 102. In addition, FIG. 7D illustrates an example in which the display range of the seed content 104 (“R”) is wider than in FIG. 7C.

In any of FIGS. 6 and 7, the shape of the area of the content is not particularly limited, and various shapes such as a square, a rectangle, a polygon, a circle, and so forth may be used. In addition, in the content arrangement, various shapes such as concentric circles, a random arrangement, and so forth may be used. In addition, the arrangement order may not be purely a score order or may be a random order.

According to the user interface described above, the booming or current information of the world may be immediately confirmed while watching the video content. In addition, things that concern the user (weather, traffic information, and so forth) may be confirmed at any time. In addition, it is also possible to carry out examination when the user wants to know more.

In addition, the content close to/far from the user's interests may be found and selected from the displayed booming content by merely scrolling up and down without changing the screen. In addition, relevance to the topic, the knowledge, a relevant person/event with respect to a specific target (a celebrity or the like)/event may be visually recognized.

In addition, it is possible to expand a range of the user's interests and also to extract meaningful information for the user from a large quantity of information accumulated on the World Wide Web (www) and so forth.

### 2. Example of Configuration of System Relevant to Present Embodiment

Next, an example of the configuration of the system relevant to the present embodiment will be described based on the algorithm extracting the pieces of content 106 and 108. In the present embodiment, “knowledge” and “trends (booming)” in the world are used, and the pieces of content 106 and 108 (in particular, the pieces of content 106) are provided as information for widening the user's interests. The pieces of content 106 relevant to the content 104 correspond to the “knowledge,” and the pieces of content 106 having a high booming value correspond to the “trends.”

Nowadays, information currently present in the world is increasing explosively and is diversifying. In particular, places in which ordinary people provide information have become pervasive with the development of the Web. Meanwhile, the total number of the pieces of content that the user may see is limited. For this reason, effectively sending a large quantity of information to the user is becoming an important topic. From this point of view, an approach using the connection (relevance) of the information and an approach using the “booming” of the information are employed in the present embodiment.

The approach using the “connection” of the information and an approach using the “booming” of the information have merits and demerits. The approach using the “connection” of the information provides information connected to the user's interests and information in which the user is likely to feel interest. In this case, there are demerits that the change in information is short and is likely to be tired of. This is due to that the connection relevance is static information to some extent and the target of the user's interests is fixed.

The approach using the booming provides newest information in consideration of the booming and also provides information having a high watching value that the user still does not know about. In this case, there is a demerit that the user does not individually have an interest because the booming is general.

For this reason, specific information in which the user feels interest is used as a key, and the user is provided with information using the connection information and the booming information for the same in the present embodiment. In this case, the user is provided with the information using the score (degree of importance) of the information to be provided. The score (degree of importance) of the information to be provided is used by mixing the connection score (connection intensity) and the booming score.

In addition, the “trend” and the “booming” indicate the degree of popularity or interest with respect to a specific topic in a predetermined group. In addition, the “booming data” and the “booming score (booming value) indicate the degree of popularity or concern with respect to the predetermined topic in the predetermined group. For example, evaluation is carried out from the state in which an amount of information regarding the topic is large in a predetermined period in the Internet, broadcasting, and so forth. In particular, it is detected that phrases relevant to the most recent topic are written in a predetermined homepage. For example, the booming score may be evaluated to be high based on the fact that there are many pages including the relevant phrases on Twitter or the like. In addition, evaluation may be carried out based on the frequency with which phrases relevant to the most recent topic are searched in the Internet, and the booming score may thus be evaluated to be high when the relevant phrases are searched frequently. Aside from this, it is also possible to evaluate the booming score from an increasing rate of search frequency, and the booming score may be determined to be high when the increasing rate is high. In addition, it is also possible to evaluate the booming score based on information regarding marketing. For example, the booming score may be evaluated to be high when many products relevant to the topic are sold.

FIG. 8 is a schematic diagram illustrating a main part of the system of the present embodiment. The system of the present embodiment includes an input unit 202, an output unit 204, an output information calculation unit 206, a display control unit 207, booming data (a database) 208, connection data (a database) 210, and an operation input unit 211. Information to be acquired is input to the input unit 202. In the example of FIG. 1, information on the content 104 is input to the input unit 202. Information input to the input unit 202 (input information) is sent to the output information calculation unit 206. A relevance information acquisition unit 206a of the output information calculation unit 206 extracts information relevant (connected) to the content 104 from the connected data 210.

In addition, a trend information acquisition unit 206b of the output information calculation unit 206 acquires strong booming information from the booming data 208 with respect to the relevant information extracted from the connection data 210. An information extraction unit 206c of the output information calculation unit 206 outputs information extracted based on the intensity of relevance and the intensity of the booming to the output unit 204. The output unit 204 is a display such as a liquid crystal display (LCD), or the like, for example. The display control unit 207 carries out control for displaying information extracted based on the intensity of the relevance and the intensity of the booming. In particular, the display control unit 207 carries out the control for displaying the display described with reference to FIGS. 1 to 7 on the display unit (output unit 204). In addition, the operation input unit 211 is a component such as a touch pad (a touch panel), a mouse, a keyboard, and so forth, and has an operation input by the user. The display control unit 207 controls the display in accordance with the operation of the user input to the operation unit 211.

In addition, the components shown in FIG. 8 may include a central operation processing device such as a circuit (hardware) or a CPU, and a program (software) for functioning as the same. In this case, the program may be stored in various recording media such as a hard disk, various memories, or an externally inserted disc-type recording medium. In addition, the program may be stored in the various memories, the recording medium, and so forth by being downloaded via a communication circuit network such as the Internet or the like.

FIG. 9 is a flowchart illustrating a process of the present embodiment. First, in step S10, information is input to the input unit 202. Next, in step S12, the connection data 210 is used, and the relevance information connected to the input information is acquired. Next, in step S14, the booming data 208 is used, and the trend information regarding the acquired relevance information is acquired. Next, in step S16, the information is output from the output unit 204.

### 3. Specific Example of Configuration of Present Embodiment

FIG. 10 is a schematic diagram illustrating a specific example of the configuration of the present embodiment. In the example illustrated in FIG. 10, the example in which the system 100 is configured by the server 300 and the television receiver 400 is illustrated.

The seed content 104 being watched by the user is input to the input unit 202. The content 104 includes information, for example, cast members, program titles, and so forth. Here, the cast members are referred to as a relevant person group A. The output information calculation unit 206 extracts a celebrity group B connected to the relevant person group A from the connection data 210a of the celebrities. Here, a celebrity relevance calculation unit 220 illustrated in FIG. 10 calculates the connection of a celebrity in advance from the information of any external server to be reflected on the connection data 210a of the celebrity. Here, the celebrity relevance calculation unit 220, as an example, calculates the connection of the celebrity in advance based on Wikipedia to be reflected on the connection data 210a of the celebrity.

In addition, the booming information extraction unit 230 acquires the booming data regarding the celebrity, and reflects the booming score on the information regarding the celebrity stored in the booming data 208a. Here, the booming information extraction unit 230, as an example, acquires the booming data regarding the celebrity from Twitter, and reflects the booming score on the information regarding the celebrity stored in the booming data 208a. The output information calculation unit 206 acquires the strong booming information on the celebrity group B extracted from the connection data 210a of the celebrity, from the booming data 208a. The output information calculation unit 206 outputs the information to the output unit 204 based on the intensity of the relevance and the intensity of the booming.

In addition, when the connection and the booming are acquired, an information source may be filtered. For example, when the user does not use Twitter but normally uses Facebook, Facebook is used as the information source. For example, the information indicating that the user uses Facebook is sent from the television receiver 400 to the server 300, which may be recognized by the server 300, and Facebook may thus be used instead of Twitter as the information source.

Next, a specific process of the output information calculation unit 206 will be described. FIG. 11 is a flowchart illustrating a specific process of the present embodiment. It is first assumed that relevance depth D searched on the relevant person group A and a number of acquired pieces of information N are given. First, in step S20, content C is acquired as the content 104 being watched. Next, in step S22, a seed group Rs for acquiring the relevance, a seed group Bs for acquiring a topic, and an initial value of a depth K being searched are set. In step S24, it is determined whether K is equal to or less than D, and the loop of step S24 to step S26 is entered when K is equal to or less than D.

In step S26, a seed group including the seed group Rs for acquiring the relevance and the seed group Bs for acquiring the topic is acquired and is regarded as a new Bs value (Bs<−Rs U Bs). Accordingly, the celebrity group Bs is expanded by the Rs. Accordingly, the celebrity group connected to the Rs thus far is searched to be set as a new Rs. At the same time, the value of the flag K is incremented by one (K<−K+1). Accordingly, the relevant seed group Bs proceeded by one hop may be obtained. By repeating the loop of step S24 to step S26, a wide range of the seed group Bs that is less relevant is searched.

In step S24, when K is greater than D, step S28 carried out. In step S28, the booming information group B regarding the search result Bs is acquired. The information group B is acquired in large quantities, and the information groups B are thus sorted in accordance with the scores in step S30. In step S32, N cases out of the information groups B are acquired and output in view of the scores. Here, as an example, the upper N cases are output from the information groups B.

FIG. 12 is a schematic diagram illustrating a score calculation technique. Here, the intensity of the connection is made to match the intensity of the booming. As an example, sorting is carried out based on (1) a product of a connection score a and a booming score b or (2) a sum of the connection score a and the booming score b. Alternatively, (3) a log of the connection score and the booming score is taken, and then sorting is carried out based on the log. In any case, the score is higher when the connection is stronger, and other methods are also possible as long as the method has the higher score when the booming is stronger.

FIG. 13 is a schematic diagram illustrating a specific algorithm. It is assumed that the number of pieces of information to be acquired is three (N=3), the number of hops to be searched is two (K=2), and the celebrity A is connected to the content being watched. In this case, the connection relations among the celebrities A, B, C, and D are illustrated as connection scores of FIG. 13A. In addition, booming scores of the information a′, a″, b′, b″, c′, c″, d′, and d″ of the respective celebrities A, B, C, and D are illustrated as scores of FIG. 13B.

FIG. 14 is a schematic diagram illustrating that the celebrities B to D are acquired by increasing the number of hops with respect to the celebrity A. First, the celebrity A is acquired based on the seed content 104 being watched. Here, the celebrity A is a celebrity who actually appears in the content 104. Next, the celebrities B and C are acquired as celebrities within a distance of one hop. Next, the celebrity D is acquired as a celebrity within a distance of two hops.

FIG. 15 is a schematic diagram illustrating an example of calculating scores. Here, by the method (1) of FIG. 12, the score is calculated from the product of the connection score and the booming score. In FIGS. 13B and 15, the information a′ and a″ is information relevant to the celebrity A. In addition, the information b′ and b″ is information relevant to the celebrity B, the information c′ and c″ is information relevant to the celebrity C, and the information d′ and d″ is information relevant to the celebrity D.

For example, since the information a′ and a″ regarding the celebrity A is directly relevant to the celebrity A, the connection score is 1. In addition, as shown in FIG. 13B, the booming scores of the information a′ and a″ are 0.8 and 0.5, respectively. Accordingly, as shown in FIG. 15, the score of the information a′ is 1×0.8=0.8. In addition, the score of the information a″ is 1×0.5=0.5.

Since the information b′ and b″ regarding the celebrity B is relevant to the celebrity B, the connection score is 0.6 as shown in FIG. 13A. In addition, as shown in FIG. 13B, the booming scores of the information b′ and b″ are 0.8 and 0.4, respectively. Accordingly, the score of the information b′ is 0.6×0.8=0.48 as shown in FIG. 15. In addition, the score of the information b″ is 0.6×0.4=0.24.

According to the method described above, as shown in FIG. 15, scores for the information a′, a″, b′, b″, c′, c″, d′, and d″ are calculated. As a result, ranking of each piece of information may be carried out based on the scores by calculating the scores based on the connection score and the booming score. The three higher cases are extracted based on the scores and are output as a result of step S32 of FIG. 11.

The score calculation is carried out by combining the connection score, the booming score, and scores in which the connection score and the booming score are combined (matching scores). For example, as a method of acquiring the N cases, the following variations may be considered:

N cases having high matching scores;
information having a highest booming score (matching score) for each of N celebrities having high connection scores;
N/n cases of celebrities, which are also possible in each of n cases; and
the method carried out on the target having a booming score (connection score) of a predetermined number or higher.

For example, in the first method, the three upper cases of the matching scores are extracted (symbol circle “O” of FIG. 15). In the second method, the three upper cases of the connection score are extracted and the case having the highest booming score is extracted (symbol “square” of FIG. 15). In addition, in the third method, the three upper cases of the matching score are extracted under the condition that the booming score be 0.7 or more (symbol Δ of FIG. 15).

In the case of the first method, since the information a′ and a″ directly relevant to the celebrity A has a high connection score (=1), it is output as a result of step S32 even when the booming score is relatively low. In addition, in the case of the second method, the information a′, b′, and c′ having high booming scores may be extracted. In addition, in the case of the third method, the information b′ and d′ having high booming scores may be extracted even when the connection score is relatively low.

As such, by combining the connection with the booming, not only the information having high relevance to the input information but also the information having a trend but being relatively less relevant to the input information may be extracted and output.

In addition, since the amount of calculating the scores is reduced, the information of the booming data 208 may not be unconditionally acquired when the booming score is lower than a predetermined filtering threshold. This is because the data having the low booming score may be regarded to have a low utility value for the user. This allows the calculation amount to be reduced. In addition, in this case, the filtering threshold using the booming score may be calculated based on the connection score. That is, the information having a high connection score and a strong connection to the input information causes the booming filtering to be weakened. Accordingly, more niche information may be extracted from the information having a strong connection and thus search according to the desire of the user becomes possible.

FIG. 16 is a schematic diagram illustrating an example in which each piece of information is disposed based on the calculated score. FIG. 16A illustrates an example in which each piece of information is sorted based on the value of the matching score. In this case, the information having a higher matching score is displayed in order from the upper side.

In addition, FIG. 16B illustrates an example in which information is sorted based on the value of the connection score, the information having a higher connection score is displayed in order from the upper side (when the values of the connection scores are equal to each other, the information is arranged side-to-side) and is sorted based on the values of the booming scores, and the information having a high booming score is displayed on the left.

In addition, FIG. 16C illustrates an example in which the connection score and the booming score are used for two-dimensional mapping. In a similar way to FIG. 16B, information is sorted based on the values of the connection scores, and the information having a high connection score is displayed in order from the upper side (when the values of the connection scores are equal to each other, the information is arranged side-to-side). In addition, an example in which the information is sorted based on the values of the booming scores and the information having a high booming score is displayed farther to the right is illustrated.

By carrying out an arrangement as shown in FIGS. 16A and 16C, it is possible to arrange the information in accordance with the values of the booming and the connection to the seed content 104 as in the pieces of content 106 in the vertical band of FIG. 1.

When the connection score and the booming score are calculated, a uniform calculation method may not be used for all users, and individualization of the score calculation method may be carried out for each user. FIG. 17 is a schematic diagram illustrating the individualization of the score calculation method by the user. FIG. 17A is a schematic diagram illustrating an example of ratios of the connection score and the booming score used by the users. In the example illustrated in FIG. 17A, the user A has a ratio of 20% connection and 80% booming. In addition, the user B has a ratio of 80% connection and 20% booming. The ratios described above are multiplied by the calculations of the scores according to the example of FIG. 15 such as the connection score and the booming score to obtain the matching score. For example, in the case of the user A, the matching score of the information a′ is (1×20%)×(0.8×80%)=0.128.

The ratios shown in FIG. 17A may be changed in accordance with the feedback result of the content watching history of the user as shown in FIG. 17B. As shown in FIG. 17B, when the ratio of any user is 50% connection and 50% booming (center of FIG. 17B), the ratio is changed to a ratio of 60% connection and 40% booming as shown on the left side of FIG. 17B when the user has watched content having a strong connection score many times. In addition, when the user has watched content having a strong booming score, the ratio is changed to a ratio of 40% connection and 60% booming as shown in FIG. 17B.

Next, variations of the present embodiment will be described with reference to drawings. In the example described above, although the information of the content 104 being watched on the television receiver by the user is input to the input unit 202, the present disclosure is not limited thereto. FIG. 18 is a schematic diagram illustrating an example in which the user directly inputs the celebrity on whom information is to be obtained. In the example illustrated in FIG. 18, an example in which the output information calculation unit 206 acquires information on the celebrity A when the “celebrity group A” in conformity with the user's interests is input to the input unit 202 is illustrated. In this case, for example, among the pieces of content 108 in the horizontal band of FIG. 1, the celebrity group A in conformity with the user's interests is input to the input unit 202. In addition, the interest information of the user may be acquired based on the operation history of the user in the television receiver, and the acquired interest information may be input to the input unit 202. The subsequent process is the same as in FIG. 10, and the same process is carried out using the “relevant person group A” of FIG. 8 as the “celebrity group A.”

In addition, although Wikipedia, Twitter, and so forth are used as information sources of the connection data 210a and the booming data 208a in FIGS. 10 and 18, IMDb, flickr, and so forth may be used instead of Wikipedia as the information source. In addition, instead of Twitter, an information source such as Facebook, RSS, news articles, and so forth may be used. In addition, information may be acquired from the general Web.

FIG. 19 illustrates an example in which the user directly inputs the “celebrity A” from the television receiver. In this case, the subsequent process is the same as in FIG. 10, and the same process is carried out using the “relevant person group A” of FIG. 10 as the “celebrity A.”

FIG. 20 is a schematic diagram illustrating an example in which information other than that on the celebrity is input to the input unit 202. In the example illustrated in FIG. 20, a place group A of the content being watched (location, and so forth) is input. The output information calculation unit 206 extracts a place group B connected to the place group A from the connection data 210b of the place. Here, as an example, the place relevance calculation unit 220 shown in FIG. 20 calculates the connection of the place in advance based on flickr, and reflects the connection on each place stored in the connection data 210b of the place as a connection score.

In addition, a booming information extraction unit 230, as an example, acquires booming data regarding the place group from Twitter, and reflects the booming score in the information regarding the place stored in the booming data 208b. The output information calculation unit 206 acquires the strong booming information regarding the place group B extracted from the connection data 210b, from the booming data 208b. The output information calculation unit 206 then outputs the information based on the intensity of the relevance and the intensity of the booming

FIG. 21 is a schematic diagram illustrating an example in which information on complementation between information is provided. In the example illustrated in FIG. 21, the relevant person group A (cast members, and so forth) of the content being watched, and information on the user's interests are input to the input unit 202. The output information calculation unit 206 extracts the celebrity group B located between the relevant person group A and the information on the user's interests. That is, the output information calculation unit 206 extracts the celebrity group B connecting between the relevant person group A and the information on the user's interests. The celebrity group B is an information group located between the relevant person group A and the information on the user's interests. The subsequent process is the same as in FIG. 10.

According to the example illustrated in FIG. 21, the user may acquire not only information regarding the content 104 being watched and high booming information but also content in conformity with the user's interests. Accordingly, the user may acquire the information that is relevant to the content 104 being watched, is trending in the world, and is also in conformity with the user's interests. In addition, the information acquired herein corresponds to the pieces of content 106 in the vertical band of FIG. 1, and in particular, corresponds to the pieces of content 106 disposed below the content 106a and arranged toward the pieces of content 108. By scrolling the pieces of content 106, it is possible to selectively and slowly acquire the content from the pieces of trending content up to the content matching the user's interests.

Here, the information connecting two pieces of information described with reference to FIG. 21 will be described in detail based on FIG. 22. In the example illustrated in FIG. 22, the content 109 (celebrity group B) is illustrated to connect the content 104 being watched and the user's interests. The content 106a having strong relevance to the content 104 being watched is extracted, and the celebrity group B is extracted as information connecting the content 106a and the content 108 in which a user's interest is strong. The celebrity group B corresponds to the content disposed below the content 104a among the pieces of content 106 in the vertical band of FIG. 1. As such, the content 104 being watched and the content 108 in conformity with the user's interests are disposed at both ends, the information (celebrity group B) is disposed therebetween, and it is possible to present the information connecting the content 104 being watched and the content 106 of the user's interests. Accordingly, the user may be provided with the information close to the content 108 of the user's interests from the content 104 being watched. As shown in FIG. 22, more pieces of content may be arranged in accordance with the booming scores in each of the pieces of content 109. Therefore, by disposing the content according to the booming score between adjacent pieces of content 109, a plurality of pieces of content (corresponding to the pieces of content 106 in the vertical band of FIG. 1) transitioning according to the interest and the booming may be disposed between the content 104 and the content 108.

In FIG. 22, the content has stronger relevance to the content 104 being watched and weaker relevance to the interest content 106 when the celebrity group B is disposed to be closer to the content 104 being watched (left side of FIG. 22). On the other hand, the content has strong relevance to the interest content 106 and weaker relevance to the content 104 being watched when the celebrity group B is disposed to be closer to the interest content 106 (right side of FIG. 22). By arranging the pieces of content 106 in the vertical band of FIG. 1 in this way, the user may freely read from the content 106 having strong relevance to the content 104 being watched to the content 106 having strong relevance to the interest content, thereby selecting desired content.

In addition, by acquiring the information toward the direction opposite to the path from the content 106a to the content 108 in FIG. 22, the pieces of content disposed above the content 106a may be acquired in the pieces of content 106 in the vertical band of FIG. 1.

In addition, although the information connecting the content 104 being watched and the interest content 108 is acquired in the examples of FIGS. 21 and 22, the present embodiment is not limited thereto. For example, the content being watched and the content that is already recorded may be disposed at both ends of FIG. 22, and information connecting the two pieces of content may be disposed therebetween. In addition, different pieces of interest content of two users may be disposed at both ends of FIG. 22, and information connecting the two pieces of content may be disposed therebetween.

In addition, acquired information may be changed in consideration of environment. For example, the interest content of persons who are with the user may be used to acquire information connected to the interest content of the user. In addition, the current location of the user may be determined, and information connecting the information based on the place and the interest content of the user may be acquired.

FIG. 23 is a schematic diagram illustrating a technique of extracting the content 109 connecting the content 106a and the content 108 in FIG. 22. The information connecting two pieces of information (the content 106a and the content 108) is generated by obtaining an optimal path connecting the two (the content 106a and the content 108) among all connection data. The numbers shown in FIG. 23 indicate connection scores between adjacent pieces of content. In this case, a graph search algorithm such as the Dijkstra method, A* algorithm, and so forth may be used.

In the example illustrated in FIG. 23A, the example in which the content having a connection between the content 106a and the content 108 is extracted, and a path 300 having the smallest number of hops between the content 106a and the content 108 is obtained is illustrated. In this case, the content 109a and the content 109b located along the path 300 are extracted as information between two pieces of content 106a and 108.

In addition, in the example illustrated in FIG. 23B, the example in which the content having a connection between the content 106a and the content 108 is extracted, and a path 310 having the highest connection score between the content 106a and the content 108 is obtained is illustrated. In this case, the pieces of content 109c to 109e located along the path 310 are extracted as information between two pieces of content 106a and 108.

FIG. 24 is a schematic diagram illustrating another example of FIG. 10. In the example illustrated in FIG. 24, the keyword group A that the user wants to check every morning is registered in advance. When a specific time arrives every morning or when the user requests the content acquisition, the keyword group A is sent to the output information calculation unit 206. The subsequent process is the same as in FIG. 10, and the same process is carried out using the “relevant person group A” of FIG. 10 as the “keyword group A” and using the “relevant person group B” as the “keyword group B.”

According to the configuration of FIG. 24, the user registers the keyword group A in advance, and it is thus possible to acquire the strong booming information within the keyword group B having strong relevance to the keyword group A.

According to the present embodiment described above, it is possible to extract and output information in which the user is likely to feel interest based on information connection. In addition, it is possible to extract and output fresh information that the user does not know about based on booming. It is thus possible to effectively extract information that the user wants to have among information flooding in large quantities.

It should be understood by those skilled in the art that various modifications, combinations, sub-combinations and alterations may occur depending on design requirements and other factors insofar as they are within the scope of the appended claims or the equivalents thereof.

Note that the present technology may also be configured as below.

1. An information processing apparatus including: a display; and a controller to control: display of a current program; display of a plurality of first images in a first arrangement, wherein each first image corresponds to content of the current program; and display of a plurality of second images in a second arrangement, wherein each second image corresponds to content associated with a user.
2. The information processing apparatus of 1, wherein the first arrangement is a first axis.
3. The information processing apparatus of 2, wherein the controller controls display of the first images by aligning the first images on the first axis in order based on relevance of each first image to the content of the current program.
4. The information processing apparatus of 3, wherein the controller controls scrolling of the first images, wherein, in the event that the first images are scrolled in a direction of increased relevancy of each first image to the content of the current program, the controller controls the display of each successive first image to be more relevant to a user preference, and wherein, in the event that the first images are scrolled in a direction of decreased relevancy of each first image to the content of the current program, the controller controls the display of each successive first image to be less relevant to the user preference.
5. The information processing apparatus of 4, including an output information calculation unit configured to determine the relevance of each first image to the content of the current program by calculating a relevance score for each first image, the output information calculation unit including: a relevance information acquisition unit configured to extract information relevant to the current program; a trend information acquisition unit configured to acquire booming data for the extracted information, wherein the booming data indicates a degree of popularity of the first image relative to the content of the current program as determined during a predetermined period of Internet usage; and an information extraction unit configured to generate the relevance score based on the extracted information and the booming data.
6. The information processing apparatus of 1, wherein the second arrangement is a second axis.
7. The information processing apparatus of 6, wherein the controller controls display of the second images by aligning the second images on the second axis in order based on a relevance of each second image to the content associated with the user.
8. The information processing apparatus of 1, wherein the controller receives a selection of a first image or a second image, and controls display of an updated program associated with the selected image, wherein the updated program is displayed at a location where the current program was displayed.
9. The information processing apparatus of 8, wherein the controller controls the display by removing the plurality of first images from the display and displaying a plurality of third images in the first arrangement, wherein each third image corresponds to content of the updated program.
10. The information processing apparatus of 1, wherein: the controller receives an instruction as input to change display of the first images, and in the first arrangement, each of the first images is displayed a predetermined distance from the current program such that the first images surround the current program.
11. The information processing apparatus of 10, wherein a length of the predetermined distance is proportional to a relevance of the corresponding first image to the current program.
12. A computer-implemented method executed by a processor, the method including: displaying a current program; displaying a plurality of first images in a first arrangement, wherein each first image corresponds to content of the current program; and displaying a plurality of second images in a second arrangement, wherein each second image corresponds to content associated with a user.
13. The method of 12, wherein the first arrangement is a first axis.
14. The method of 13, wherein the first images are aligned on the first axis in order based on relevance of each first image to the content of the current program.
15. The method of 14, including: scrolling of the first images; in the event that the first images are scrolled in a direction of increased relevancy of each first image to the content of the current program, displaying each successive first image to be more relevant to a user preference; and in the event that the first images are scrolled in a direction of decreased relevancy of each first image to the content of the current program, displaying each successive first image to be less relevant to the user preference.
16. The method of 12, wherein the second arrangement is a second axis.
17. The method of 16, including aligning the second images on the second axis in order based on a relevance of each second image to the content associated with the user.
18. The method of 12, including: receiving a selection of a first image or a second image; and displaying an updated program associated with the selected image, wherein the updated program is displayed at a location where the current program was displayed.
19. The method of 18, including: removing the plurality of first images from the display; and displaying a plurality of third images in the first arrangement, wherein each third image corresponds to content of the updated program.
20. The method of 12, including: receiving an instruction as input to change display of the first images, and in the first arrangement, displaying each of the first images a predetermined distance from the current program such that the first images surround the current program.
21. The method of 20, wherein a length of the predetermined distance is proportional to a relevance of the corresponding first image to the current program.
22. The method of 12, including determining the relevance of each first image to the content of the current program by calculating a relevance score for each first image.
23. The method of 22, wherein calculating the relevance score includes combining a connection score and a booming score, the connection score indicating a degree of relevance of information extracted from the current program, and the booming score indicating a degree of popularity of the first image relative to the content of the current program as determined during a predetermined period of Internet usage.

### REFERENCE SIGNS LIST

100 System
202 Input unit
206 Output information calculation unit
206a Relevance information acquisition unit
206b Trend information acquisition unit
206c Information extraction unit
207 Display control unit

1. An information processing apparatus comprising:
a display; and
a controller to control:
display of a current program;
display of a plurality of first images in a first arrangement, wherein each first image corresponds to content of the current program; and
display of a plurality of second images in a second arrangement, wherein each second image corresponds to content associated with a user.

2. The information processing apparatus of claim 1, wherein the first arrangement is a first axis.

3. The information processing apparatus of claim 2, wherein the controller controls display of the first images by aligning the first images on the first axis in order based on relevance of each first image to the content of the current program.

4. The information processing apparatus of claim 3, wherein the controller controls scrolling of the first images,
wherein, in the event that the first images are scrolled in a direction of increased relevancy of each first image to the content of the current program, the controller controls the display of each successive first image to be more relevant to a user preference, and
wherein, in the event that the first images are scrolled in a direction of decreased relevancy of each first image to the content of the current program, the controller controls the display of each successive first image to be less relevant to the user preference.

5. The information processing apparatus of claim 4, further comprising an output information calculation unit configured to determine the relevance of each first image to the content of the current program by calculating a relevance score for each first image, the output information calculation unit comprising:
a relevance information acquisition unit configured to extract information relevant to the current program;
a trend information acquisition unit configured to acquire booming data for the extracted information, wherein the booming data indicates a degree of popularity of the first image relative to the content of the current program as determined during a predetermined period of Internet usage; and
an information extraction unit configured to generate the relevance score based on the extracted information and the booming data.

6. The information processing apparatus of claim 1, wherein the second arrangement is a second axis.

7. The information processing apparatus of claim 6, wherein the controller controls display of the second images by aligning the second images on the second axis in order based on a relevance of each second image to the content associated with the user.

8. The information processing apparatus of claim 1, wherein the controller receives a selection of a first image or a second image, and controls display of an updated program associated with the selected image, wherein the updated program is displayed at a location where the current program was displayed.

9. The information processing apparatus of claim 8, wherein the controller controls the display by removing the plurality of first images from the display and displaying a plurality of third images in the first arrangement, wherein each third image corresponds to content of the updated program.

10. The information processing apparatus of claim 1, wherein:
the controller receives an instruction as input to change display of the first images, and
in the first arrangement, each of the first images is displayed a predetermined distance from the current program such that the first images surround the current program.

11. The information processing apparatus of claim 10, wherein a length of the predetermined distance is proportional to a relevance of the corresponding first image to the current program.

12. A computer-implemented method executed by a processor, the method comprising:
displaying a current program;
displaying a plurality of first images in a first arrangement, wherein each first image corresponds to content of the current program; and
displaying a plurality of second images in a second arrangement, wherein each second image corresponds to content associated with a user.

13. The method of claim 12, wherein the first arrangement is a first axis.

14. The method of claim 13, wherein the first images are aligned on the first axis in order based on relevance of each first image to the content of the current program.

15. The method of claim 14, further comprising:
scrolling of the first images;
in the event that the first images are scrolled in a direction of increased relevancy of each first image to the content of the current program, displaying each successive first image to be more relevant to a user preference; and
in the event that the first images are scrolled in a direction of decreased relevancy of each first image to the content of the current program, displaying each successive first image to be less relevant to the user preference.

16. The method of claim 12, wherein the second arrangement is a second axis.

17. The method of claim 16, further comprising aligning the second images on the second axis in order based on a relevance of each second image to the content associated with the user.

18. The method of claim 12, further comprising:
receiving a selection of a first image or a second image; and
displaying an updated program associated with the selected image,
wherein the updated program is displayed at a location where the current program was displayed.

19. The method of claim 18, further comprising:
removing the plurality of first images from the display; and
displaying a plurality of third images in the first arrangement,
wherein each third image corresponds to content of the updated program.

20. The method of claim 12, further comprising:
receiving an instruction as input to change display of the first images, and
in the first arrangement, displaying each of the first images a predetermined distance from the current program such that the first images surround the current program.

21. The method of claim 20, wherein a length of the predetermined distance is proportional to a relevance of the corresponding first image to the current program.

22. The method of claim 12, further comprising determining the relevance of each first image to the content of the current program by calculating a relevance score for each first image.

23. The method of claim 22, wherein calculating the relevance score comprises combining a connection score and a booming score, the connection score indicating a degree of relevance of information extracted from the current program, and the booming score indicating a degree of popularity of the first image relative to the content of the current program as determined during a predetermined period of Internet usage.
